(19) United States
(12) Patent Application Publication
(10) Pub. No.: US 2025/0111431 A1
(43) Pub. Date: Apr. 3, 2025

(54) SYSTEMS AND METHODS FOR INTELLIGENT LENDER SELECTION

(71) Applicant: Cox Automotive, Inc., Atlanta, GA (US)

(72) Inventors: Rahul Gupta, Cumming, GA (US); Udit Luthur, Kennesaw, GA (US)

(21) Appl. No.: 18/477,998

(22) Filed: Sep. 29, 2023

(51) Int. Cl. G06Q 40/03

(52) U.S. Cl. CPC G06Q 40/03

(57) ABSTRACT

Methods for intelligent lender selection is provided. A loan application acceptance package is received from each of a plurality of lending entities for a loan application. Loan variables including a buy lending rate and a margin are extracted from the loan application acceptance package. A target margin is predicted based on the buy lending rate and the margin for each or the plurality of lending entities and a customer profile of a customer associated with the loan application. A lending entity from the plurality of lending entities is selected based on the target margin.

### BACKGROUND

The vehicle purchasing process can be complex and overwhelming. Consumers who undertake the process first need to select a vehicle at a vehicle dealer from a vast pool of options. After narrowing down to one vehicle from the pool, the customer then proceeds to the financing process. The financing process generally involves the customer providing personal information to Finance and Insurance (F&I) division of the vehicle dealer. Depending on the personal information and a sale price of the selected vehicle, the F&I division determines one or more lender entities to submit a loan application to finance transfer of the vehicle to the customer. Some of the one or more lending entities approve the loan application. A manager or user in the F&I division spends time reviewing the approvals to determine one approval that is most beneficial to both the vehicle dealer and the customer. This manual process lends errors, leading to unpleasant consumer experiences and increased possibility of abandonment as the customer leave the platform while waiting for dealership notification. In addition, manual review and determination of the loan parameters is not efficient resulting in potential revenue loss.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment for intelligent lender selection;

FIG. 2 is a block diagram of a vehicle transfer system;

FIG. 3 is a flow diagram of a method for intelligent lender selection; and

FIG. 4 is a block diagram of a computing device.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Finance and Insurance (F&I) divisions of vehicle dealerships contribute significantly to dealership profitability when properly managed. For example, by reducing an amount of time required in reviewing loan approval packages received from lending entities and by preparing the loan parameters to maximize the profit and customer acceptance, the F&I division can not only reduce customer walkouts during the financing process, but also increase revenue from the financed vehicle transfers. The disclosure provides processes for intelligent lender selection from one or more lending entities and by preparing the loan parameters to maximize the profit and customer acceptance.

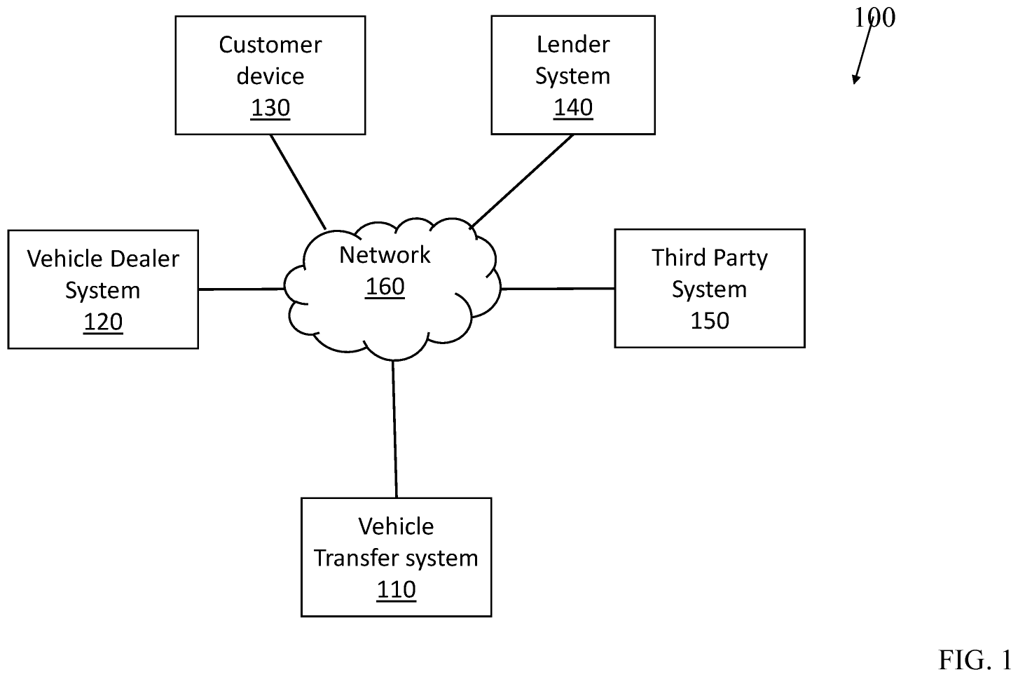

FIG. 1 illustrates an example operating environment 100 for intelligent lender selection in accordance with example embodiments of the disclosure. As shown in FIG. 1, operating environment 100 includes a vehicle transfer system 110, a vehicle dealer system 120, a customer device 130, a lender system 140, and a third party system 150. Operating environment 100 may include multiple instances of one or more of these devices and systems 120 through 150.

Operating environment 100 further includes a network 160 through which systems and devices 110 through 150 may communicate with each other. Network 160 may include any combination of local and/or wide area networks, using both wired and/or wireless communication systems. For example, network 160 includes communication links using technologies such as Ethernet, 802.11, Worldwide Interoperability for Microwave Access (WiMAX), 3G, 4G, 5G, 6G, 7G, Code Division Multiple Access (CDMA), Digital Subscriber Line (DSL), etc. Examples of networking protocols used for communicating via network 160 include Multiprotocol Label Switching (MPLS), Transmission Control Protocol/Internet Protocol (TCP/IP), Hypertext Transport Protocol (HTTP), Simple Mail Transfer Protocol (SMTP), and File Transfer Protocol (FTP). Data exchanged over network 160 may be represented using any suitable format, such as Hypertext Markup Language (HTML) or Extensible Markup Language (XML).

Vehicle transfer system 110 interacts with some or all of the other systems and devices 120 through 150 to perform vehicle transfer. Vehicle transfer may refer to sale or lease of a vehicle from a vehicle dealer to a customer of the vehicle dealer. Vehicle transfer system 110 may further communicate with some or all of the other systems and devices 120 through 150 to secure one or more forms of financing for the vehicle transfer transaction. More particularly, and as discussed in greater detail in following sections of the disclosure, vehicle transfer system 110 may facilitate intelligent lender selection to expedite financing and maximize a profit of the vehicle dealer in the financing of the vehicle transfer transaction. Although shown separately, whole or portions of vehicle transfer system 110 may be located or installed on vehicle dealer system 120.

Vehicle dealer system 120 is a computing system operated by a vehicle dealer or a vehicle retailer that provides information about the vehicle dealer, such as contact information for the vehicle dealer, information about one or more vehicles in the possession of the vehicle dealer, lending entities associated with the vehicle dealer, etc. In one embodiment, vehicle dealer system 120 is a web server that provides a publicly available website operated by the vehicle dealer. As referred to herein, a vehicle dealer or a dealership is an entity that possesses or otherwise has the right to sell, lease, rent, or temporarily transfer control of a vehicle to another entity (e.g., a customer). A vehicle dealer may be a licensed vehicle dealership or vehicle manufacturer (e.g., a business entity) or a solo independent being (e.g., a human entity) that interfaces with vehicle transfer system 110 for transferring control of a vehicle to facilitate a vehicle transfer transaction.

Customer device 130 is a computing device operated by a customer to view the information provided by vehicle dealer system 120. Customer device 130 may be a computing device that belongs to the customer, such as a personal laptop computer, desktop computer, tablet computer, or smartphone. Customer device 130 may alternatively be a computing device that a vehicle dealer provides for a customer to use. For example, customer device 130 may be a computing device that is physically located inside a vehicle dealer in a manner that is accessible to customers, which allows a customer to view the information provided by vehicle dealer system 120 during an in-person visit to the vehicle dealership. As referred to herein, a customer is a person or entity that seeks to possess or otherwise buy, lease, rent, or otherwise at least temporarily obtain control of a vehicle from another entity (e.g., a vehicle dealer). A customer may be a licensed vehicle dealership (e.g., a business entity) or a solo independent being (e.g., a person) that may interface with vehicle transfer system 110 for obtaining control of a vehicle to facilitate a vehicle transfer transaction.

Lender system 140 is operated by a lender or a lending entity, a bank, or other capital source that seeks to make funds available in a loan to another entity (e.g., to a customer for use in at least temporarily obtaining control of a vehicle from a vehicle dealer) with the expectation that the element of value will be repaid (e.g., within a certain amount of time, in addition to any interest and/or fees, either in increments or as a lump sum). Such a lending entity may be a licensed public or private group or a financial institution (e.g., a business entity or collection of individuals) or a solo independent being (e.g., a human entity) that may interface with vehicle transfer system 110 for making a loan to a customer to facilitate a vehicle transfer transaction.

Third party system 150 provides a third party application or service that processes or provides any suitable subject matter that may be used by any other system or device in operating environment 100 to enable a vehicle transfer transaction. In one embodiment, third party system 150 is operated by a financial institution (e.g., banks) that provides financial information or credit scores for any suitable users or vehicles of the platform. For example, third party system 150 may be operated by an information management service and credit information service, such as TransUnion of Chicago, Ill., Equifax Inc. of Atlanta, Ga., Experian PLC of Dublin, Republic of Ireland, Edmunds.com, Inc. of Santa Monica, Calif., Black Book auto valuation of Heart Business Media Corporation of New York, N.Y., Kelley Blue Book auto valuation of Cox Automotive of Atlanta, Ga., Plaid Technologies, Inc. of San Francisco, Calif., Twilio of San Francisco, Calif., and the like, from which data may be collected by any suitable data hub or Data Management System (“DMS”) and shared with vehicle transfer system 110). Third party system 150 may also include historical loan application data providers (for example, DealerTrack).

As other examples, third party system 150 may be operated by a risk management research entity, an ancillary goods/services provisioning entity, an entity that may provide Vehicle Service Contract (VSC) products and/or F&I products, backup and recovery provider entities, an underwriter, a loan servicer, a financial transaction electronic network, electronic signature facilitator entities, a loan agent, an investor, a social network that provides any suitable connection information between various parties, a government agency/regulator, a licensing body, a third party advertiser, an owner of relevant data, a seller of relevant goods/materials, a software provider, a maintenance service provider, or a scheduling service provider.

Although operating environment 100 and systems and devices 110 through 150 are described herein with respect to the transfer of a vehicle from a vehicle dealer to a customer, operating environment 100 can alternatively be used to transfer a different type of good or service (e.g., a real estate property, business supply, etc.) according to one or more of the concepts described in this disclosure.

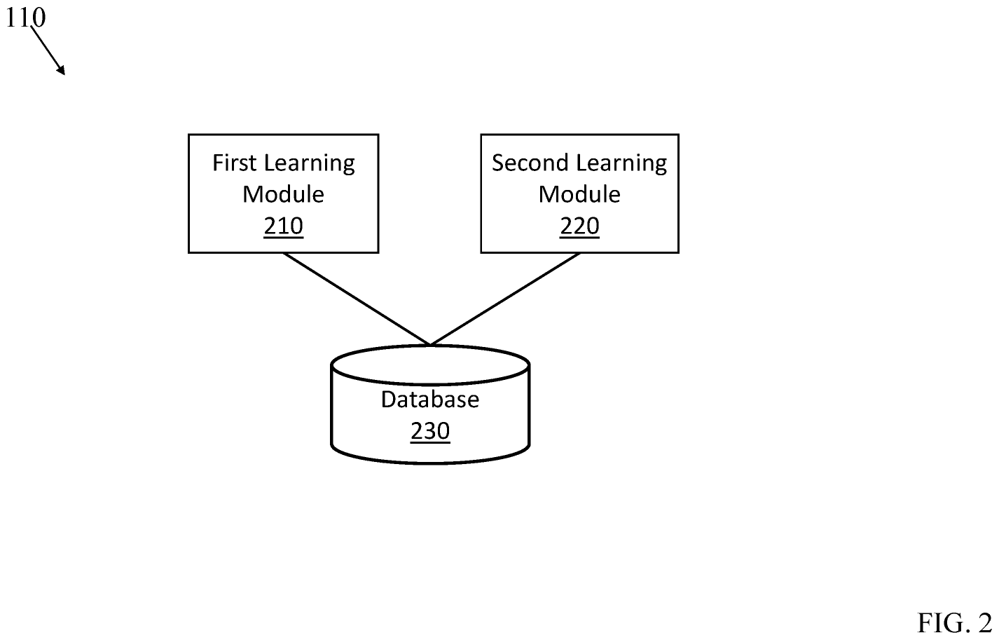

FIG. 2 illustrates vehicle transfer system 110 in accordance with example embodiments of the disclosure. As shown in FIG. 2, vehicle transfer system 110 includes a first learning module 210, a second learning module 220, and a database 230. Both first learning module 210 and second learning module 220 may include a learning algorithm which is trained using historical data stored in database 230. Historical data may include, for example, loan application data comprising a list of approved/accepted loan applications, a buy lending rate for each of the approved/accepted loan applications, a sale lending rate for each of the approved/accepted loan applications, a customer profile or customer variables associated with each of the approved/accepted loan applications, vehicle data or vehicle variables associated with each approved/accepted loan applications, and financial data or loan variables associated with each of approved/accepted loan applications. Approved loan applications may include loan applications that were approved by a lending entity for a vehicle transfer transaction. Accepted loan applications may include loan contracts or loan applications that resulted in financing of a vehicle transfer transaction. The historical data can be collected from a plurality of lending entities or third party system 150 that collects historical loan application approval data.

First learning module 210, once trained, extract loan variables including a buy lending rate, a margin, and margin limit from the loan application acceptance package received from lending entities in response to submission of the loan application by a customer. The margin can include one or more of a margin rate at the buy lending rate, a flat at the buy lending rate, and an incremental margin rate and the flat corresponding to each incremental margin rate from the buy lending rate. Second learning module 220, once trained, may predict a target margin based on the buy lending rate and the margin for each or the plurality of lending entities and a customer profile of a customer associated with the loan application. This prediction, as explained in the following sections of the disclosure, is used for intelligent lender selection for financing the transfer of the selected vehicle from the vehicle dealer to the customer.

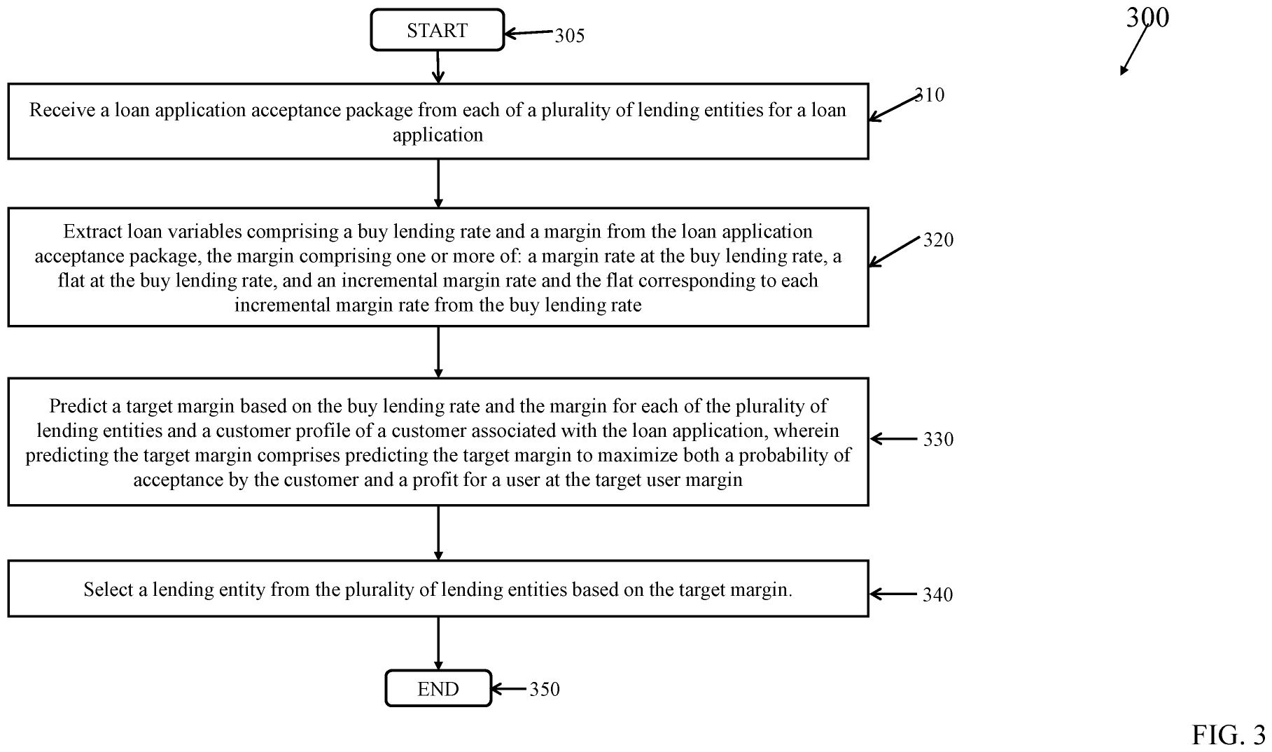

FIG. 3 is a flow chart setting forth the general stages involved in a method 300 consistent with an embodiment of the disclosure for intelligent lender selection. Method 300 may be performed by vehicle transfer system 110 as described in more detail above with respect to FIGS. 1 and 2. Ways to implement the stages of method 300 will be described in greater detail below.

Method 300 begins at starting block 305 and proceeds to stage 310 where a loan application acceptance package is received from each of a plurality of lending entities for a loan application. The loan application acceptance package can be received by vehicle transfer system 110. For example, a customer can select a vehicle to purchase at a vehicle dealer. The customer can select the vehicle either by surfing through an online listing of vehicles or by physically walking at a vehicle lot of the vehicle dealer. After selecting the vehicle, the customer may decide to buy or lease the selected vehicle through financing. To initiate the financing, the customer may be prompted to provide the customer identifier either to an administrator at the dealership or by filing an online form through customer device 130. Vehicle transfer system 110 determines a customer profile or customer variables from the customer identifier. The customer variables may include one or more of personal information (e.g., birth date, current and past home addresses, phone numbers, and/or current and past employers, etc.), customer's current income, credit scores, account information (e.g., credit cards, installment loans, mortgages or auto loans, etc.), public records (e.g., bankruptcies), and/or user characteristics (e.g., behavioral driving habit, a residency, age, gender, etc.).

In addition, vehicle transfer system 110 determines vehicle data or vehicle variables such as a sale price of vehicle, rebates, trade-in valuations, etc. of the selected vehicle from vehicle dealer system 120. Based on the customer variables and the vehicle variables, vehicle transfer system 110 determines loan parameters or deal parameters associated with a loan application by the customer for financing the transfer of the vehicle to the customer. The loan parameters may include an amount of credit or money the customer is seeking in the loan application from a lending entity, an amount of down payment the customer is willing to provide, a length of the loan (i.e., a loan term), a Loan to Value (LTV) ratio for the vehicle, lending entities parameters, etc. Vehicle transfer system 110 then submits or assists in submitting the loan application to lending entities associated with the dealership. Some or all of the lending entities to which the loan application was submitted may approve the loan application and provide the loan application acceptance package to vehicle transfer system 110.

After receiving the loan application acceptance package at stage 310, method 300 proceeds to stage 320 where loan variables including a buy lending rate and a margin are extracted from the loan application acceptance package. The margin can include one or more of a margin rate at the buy lending rate, a flat at the buy lending rate, and an incremental margin rate and the flat corresponding to each incremental margin rate from the buy lending rate. The buy lending rate is an interest rate the lending entity will charge the vehicle dealership on the loan. The margin rate is an additional rate that the dealership can add as a profit margin on top of the buy lending rate when presenting the loan variables to the customer. The flat may be a fraction of the loan amount that the lending entity will provide to the vehicle dealer as the profit margin if the customer accepts the loan offer from the lending entity. In some examples, the flat may be a fraction of the loan amount that the vehicle dealer can add to the loan amount when the customer accepts the loan offer from the lending entity. The buy lending rate and the margin are provided in the loan application acceptance package.

In some examples, each lending entity may have its own format or structure for providing the buy lending rate and the margin in the loan application acceptance package (also referred to as a deal structure). For example, a first lending entity may provide the buy lending rate and the margin in a one-page electronic document while a second lending entity may provide the buy lending rate and the margin in multiple pages. In some examples, a third lending entity may provide the buy lending rate and the margin in a table format while a fourth lending entity may provide the buy lending rate and the margin in a running text. First learning module 210 may be trained to identify the format or structure associated with the loan application acceptance packages and extract the loan variables including the buy lending rate and the margin from the loan application acceptance packages.

In accordance with example embodiments, first learning module 210, once trained, extracts the loan variables including the buy lending rate, the margin, and margin limit (if any) from the loan application acceptance packages. In addition, first learning algorithm 210, once trained, also extract a time to contract by lending entities, documents that may be asked by lending entities for contract (for example, W2, etc.) to verify standing of the customer, etc. First learning module 210 is trained based on historical loan application acceptance package. Database 230, for example, may acquire and store the historical loan application acceptance package data for a predetermined length of time (for example, 1 month, 6 months, 1 year, 5 years, etc.) and can constantly update based on new approvals. The historical loan acceptance package data can include a list of loan approval packages and the buy lending rate and the margin for each of the loan application acceptance packages on the list. The historical loan application acceptance package data can further include the car variables, the deal variables, and the customer variables for each of the loan application acceptance packages on the list. In addition, database 230 may store macro-economic variables, for example, Gross Domestic Product (GDP), inflation, unemployment rate, used vehicle index, etc.

Once having extracted loan variables at stage 320, method 300 proceeds to stage 330 where a target margin is predicted based on the buy lending rate and the margin for each or the plurality of lending entities and a customer profile of a customer associated with the loan application. The target margin is predicted to maximize both a probability or likelihood of acceptance by the customer and a profit for a user (for example, the vehicle dealer) at the target margin. For example, the higher the target margin, the higher is the profit. However, a customer may not accept loan terms with the higher target margin as the customer can get better loan terms from another retailer or vehicle dealer. In addition, the target margin may be limited by the margin limit indicated by the lending entity and another limits indicated by state or federal regulations.

In accordance with example embodiments, second learning module 220, once trained, predicts the target margin. Second learning module 220 is trained based on the historical loan application acceptance package data. As discussed above, the historical loan approval data includes a list of loan contracts that may include margins that were accepted by customers and a customer profile of the customers that accepted the margin. In addition, the historical loan approval data may include another list of loan approval data that may include margins that was not accepted by customers and a customer profile of the customers that did not accept the margins. Second learning module 220, once trained predicts the target margin for each of the plurality of lending entities based on the buy lending rate, the margin, and the customer profile.

In some examples, the historical loan approval data may include a list of loan contracts and a sale lending rate for each of the loan contracts and a customer profile of a customer that signed the loan contract. In addition, the historical approval data may include list of loan approvals that did not mature to loan contracts and a sale lending rate for each of the loan approvals presented to the customers and a customer profile of each customers that did not sign or declined the loan contract. Second learning module 220, once trained predicts the sale lending rate for each of the plurality of lending entities based on the buy lending rate, the dealer reserves, and the customer profile. The target margin is determined as a difference between the predicted sale lending rate and the buy lending rate.

Second learning module 220 may include a learning algorithm, for example, a gradient boosting algorithm. During training or learning, second learning module 220, for example, builds models sequentially to reduce errors in predictions of a previous model. The new models in the sequence are built based on the errors or residuals of the previous models. In some examples, second learning module 220 includes is a tree-based classification algorithm. For example, during the learning or the training phase, second learning module 220 makes initial set of trees for each inputs and provides or predicts a binary decision as an output for each inputs. For example, a tree based on the credit score may use the credit score as input and is trained to provide an output as yes when the credit score is greater than 700 and if not then provide an output as no. Second learning module 220 compares the predicted outcomes from the initial set of trees with historical outcomes and determines an error in prediction from the initial set of trees. Second learning module 220 then creates a next set of trees based on the errors in the previous set of trees to reduce the errors in predictions from the previous round. This process of creating new set of trees to reduce the errors in predications in the previous set of trees can be repeated for several rounds or when the errors are less than a predetermined level. The administrator can set a number of rounds for the error reduction. Second learning module 220 may include other type of learning algorithms, for example, regression-based learning algorithms.

The target margin is predicted as one or more of the margin rate at the buy lending rate, the flat at the buy lending rate, and the incremental margin rate and the flat corresponding to each incremental margin rate from the buy lending rate. In addition to the predicted target margin, vehicle transfer system 110 may determine other parameters, for example, a funding time, a lender acquisition fee (if any), dealer reserve limitations, documentary requirements for contracting, macro-economic conditions, lender stipulations, etc.

After predicting the target margin at stage 330, method 300 proceeds to stage 340 where a lending entity from the plurality of lending entities is selected based on the target margin. In one example, the lending entity of the plurality of lending entities having a highest target margin is selected for contracting. In some examples, the lending entity is selecting further based on one or more of the funding time, the lender acquisition fee (if any), the dealer reserve limitations, documentary requirements for contracting, macro-economic conditions, lender stipulations, etc. For example, a first lending entity having a higher target margin than a second lending entity of the plurality of lending entities may not be selected over the second lending entity, if the second entity has a significantly better funding time compared to the first lending entity. Similarly, a first lending entity having a higher target margin than a second lending entity of the plurality of lending entities may not be selected over the second lending entity, if the second entity has a significantly lower or no acquisition fee time compared to the first lending entity. In another example, vehicle transfer system 110 based on customer's employment and income, may predict that a first lending entity may need paystubs, W2, last year's tax returns, etc. while a second lending entity may only ask for W2. In some examples, a weight is assigned to different parameters for selecting the lending entity, and the lending entity is selected based on an aggregate weight of these parameters. In some examples, the lending entity is selected based on an association profile having an association reward associated each of the plurality of lending entities. Once having selected the lending entity from the plurality of lending entities based on the target margin at stage 340, method 300 may end at stage 350.

In some embodiments, after selecting the lending entity, vehicle transfer system 110 may assist in signing to a loan contract between the selected lending entity and the customer. For example, vehicle transfer system 110 can re-calculate a monthly payment and deal structure based on the approved sale lending rate of the selected lending entity. The approved sale lending rate is determined by adding the predicted target margin to the buy lending rate for the selected lending entity. The lean terms are updated/recalculated based on the approved sale lending rate. The updated/recalculated loan terms are presented for the customer for their review and acceptance. Once accepted, the loan contract may be signed between the selected lending entity and the customer.

In accordance with example embodiments, method 300 reduces an amount of time spent by a dealership in the lender selection process from 30-45 minutes to less than one minute. The reduction of the time in the lender selection process improves customer retention thereby improving sales. In addition, method 300 increases a profit margin for the dealership and improves lender relations.

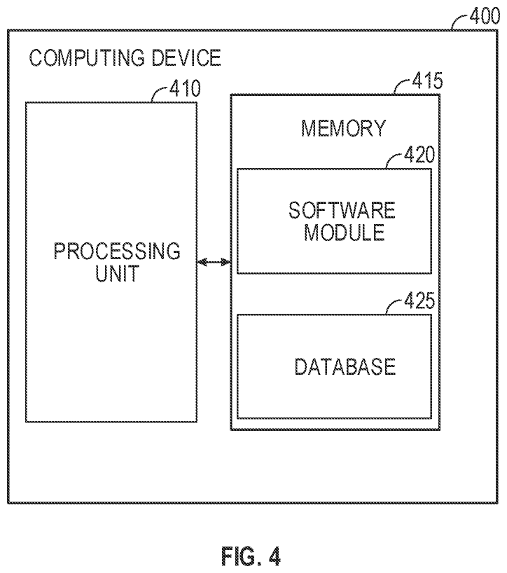

FIG. 4 shows computing device 400. As shown in FIG. 4, computing device 400 includes a processing unit 410 and a memory unit 415. Memory unit 415 includes a software module 420 and a database 425. While executing on processing unit 410, software module 420 performs, for example, processes for intelligent lender selection, including for example, any one or more of the stages from method 300 described above with respect to FIG. 3. Computing device 400, for example, provides an operating environment vehicle transfer system 110, vehicle dealer system 120, customer device 130, lender system 140, and third party system 150. Vehicle transfer system 110, vehicle dealer system 120, customer device 130, lender system 140, and third party system 150 may operate in other environments and are not limited to computing device 400.

Computing device 400 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 400 can include any computer operating environment, such as hand-held devices, multiprocessor systems, microprocessor-based or programmable sender electronic devices, minicomputers, mainframe computers, and the like. Computing device 400 can also be practiced in distributed computing environments where tasks are performed by remote processing devices. The aforementioned systems and devices are examples and computing device 400 can comprise other systems or devices.

Embodiments of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, embodiments of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a Random Access Memory (RAM), a Read-Only Memory (ROM), an Erasable Programmable Read-Only Memory (EPROM or Flash memory), an optical fiber, a portable Compact Disc Read-Only Memory (CD-ROM), and a portable pen drive. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIGS. 1 and 3 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed:

1. A method comprising:
receiving, by a device comprising at least one processor, a loan application acceptance package from each of a plurality of lending entities for a loan application;
extracting, by a first machine learning module of the device, loan variables comprising a buy lending rate and a margin from the loan application acceptance package, the margin comprising one or more of: a margin rate at the buy lending rate, a flat at the buy lending rate, and an incremental margin rate and the flat corresponding to each incremental margin rate from the buy lending rate;
predicting, by a second machine learning module of the device, a target margin based on the buy lending rate and the margin for each of the plurality of lending entities and a customer profile of a customer associated with the loan application, wherein predicting the target margin comprises predicting the target margin to maximize both a probability of acceptance by the customer and a profit for a user at the target margin; and
selecting, by the device, a lending entity from the plurality of lending entities based on the target margin.

2. The method of claim 1, further comprising:
determining loan structure for contracting with the selected lender based on the buy rate and the target margin; and
presenting the loan structure to the customer for review.

3. The method of claim 1, wherein predicting the target margin comprises limiting the target rate to a rate limit provided by the plurality of lending entities.

4. The method of claim 1, wherein selecting the lending entity from the plurality of lending entities comprises selecting the lending entity from the plurality of lending entities further based on a funding time associated with each of the plurality of lending entities.

5. The method of claim 4, wherein selecting the lending entity from the plurality of lending entities further based on the funding time associated with each of the plurality of lending entities comprising:
assigning a weight to each of the probability of acceptance by the customer, the profit for the user, and the funding time; and
selecting the lending entity from the plurality of lending entities based on aggregate weight for each of the plurality of lending entities.

6. The method of claim 1, wherein selecting the lending entity from the plurality of lending entities comprises selecting the lending entity from the plurality of lending entities further based on an association profile comprising an association reward associated each of the plurality of lending entities.

7. The method of claim 1, further comprising:
training the first machine learning module based on a historical loan application acceptance package data from the plurality of lending entities to extract the buy lending rate and the margin.

8. The method of claim 1, further comprising:
training the second machine learning module based on a historical loan application acceptance package data to predict the target margin, the historical loan application acceptance package data comprising a list of accepted loan applications, a sale rate for each of the accepted loan applications, and a buy rate for each of the accepted loan applications, a type of the margin in each of the accepted loan applications, and the customer profile for each of the accepted loan applications.

9. A system comprising:
a memory storage; and
a processing unit, the processing unit disposed in a station and coupled to the memory storage, wherein the processing unit is operative to:
receive a loan application acceptance package from each of a plurality of lending entities for a loan application;
extract, by a first machine learning module, a buy lending rate and a margin from the loan application acceptance package, the margin comprising one or more of: a margin rate at the buy lending rate, a flat at the buy lending rate, and an incremental margin rate and the flat corresponding to each incremental margin rate from the buy lending rate;
predict, by a second machine learning module, a target margin based on the buy lending rate and the margin for each of the plurality of lending entities and a customer profile of a customer associated with the loan application, wherein predicting the target margin comprises predicting the target margin to maximize both a probability of acceptance by the customer and maximize a profit for a user at the target margin; and
select a lending entity from the plurality of lending entities based on the target margin.

10. The system of claim 9, wherein the processing unit being operative to select the lending entity from the plurality of lending entities comprises the processing unit being operative select the lending entity from the plurality of lending entities further based on a funding time associated with each of the plurality of lending entities.

11. The system of claim 10, wherein the processing unit being operative select the lending entity from the plurality of lending entities further based on the funding time associated with each of the plurality of lending entities comprises the processing unit being operative to:
assign a weight to each of the probability of acceptance by the customer, the profit for the user, and the funding time; and
select the lending entity from the plurality of lending entities based on aggregate weight for each of the plurality of lending entities.

12. The system of claim 9, wherein the processing unit being operative to select the lending entity from the plurality of lending entities comprises the processing unit being operative select the lending entity from the plurality of lending entities further based on an association profile comprising an association reward associated each of the plurality of lending entities.

13. The system of claim 9, wherein the processing unit is further operative to:
train the first machine learning module based on a historical loan application acceptance package data from the plurality of lending entities to extract the buy lending rate and the margin.

14. The system of claim 9, wherein the processing unit is further operative to:
train the second machine learning module based on a historical loan application acceptance package data to predict the target margin, the historical loan application acceptance package data comprising a list of accepted loan applications, a sale rate for each of the accepted loan applications, and a buy rate for each of the accepted loan applications, a type of the margin in each of the accepted loan applications, and the customer profile for each of the accepted loan applications.

15. A non-transitory computer-readable medium that stores a set of instructions which when executed perform a method executed by the set of instructions comprising:
receiving, by a device comprising at least one processor, a loan application acceptance package from each of a plurality of lending entities for a loan application;
extracting, by a first machine learning module of the device, a buy lending rate and a margin from the loan application acceptance package, the margin comprising one or more of: a margin rate at the buy lending rate, a flat at the buy lending rate, and an incremental margin rate and the flat corresponding to each incremental margin rate from the buy lending rate;
predicting, by a second machine learning module of the device, a target margin based on the buy lending rate and the margin for each of the plurality of lending entities and a customer profile of a customer associated with the loan application, wherein predicting the target margin comprises predicting the target margin to maximize both a probability of acceptance by the customer and maximize a profit for the user at the target margin; and
selecting, by the device, a lending entity from the plurality of lending entities based on the target margin.

16. The non-transitory computer-readable medium of claim 15, wherein selecting the lending entity from the plurality of lending entities comprises selecting the lending entity from the plurality of lending entities further based on a funding time associated with each of the plurality of lending entities.

17. The non-transitory computer-readable medium of claim 16, wherein selecting the lending entity from the plurality of lending entities further based on the funding time associated with each of the plurality of lending entities comprising:
assigning a weight to each of the probability of acceptance by the customer, the profit for the user, and the funding time; and
selecting the lending entity from the plurality of lending entities based on aggregate weight for each of the plurality of lending entities.

18. The non-transitory computer-readable medium of claim 15, wherein selecting the lending entity from the plurality of lending entities comprises selecting the lending entity from the plurality of lending entities further based on an association profile comprising an association reward associated each of the plurality of lending entities.

19. The non-transitory computer-readable medium of claim 15, further comprising:
training the first machine learning module based on a historical loan application acceptance package data from the plurality of lending entities to extract the buy lending rate and the margin.

20. The non-transitory computer-readable medium of claim 15, further comprising:
training the second machine learning module based on a historical loan application acceptance package data to predict the target margin, the historical loan application acceptance package data comprising a list of accepted loan applications, a sale rate for each of the accepted loan applications, and a buy rate for each of the accepted loan applications, a type of the margin in each of the accepted loan applications, and the customer profile for each of the accepted loan applications.
